(19) United States
(12) Patent Application Publication
(10) Pub. No.: US 2010/0319176 A1
(43) Pub. Date: Dec. 23, 2010

(54) SMART SYSTEM FOR VEHICLE COSMETIC REPAIR

(75) Inventors: Holly M. Stewart, Moreland, GA (US); Keith A. Sena, Canton, MI (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/797,959

(22) Filed: Jun. 10, 2010

Related U.S. Application Data
(60) Provisional application No. 61/219,429, filed on Jun. 23, 2009.

(51) Int. Cl. B23P 23/04

(52) U.S. Cl. 29/33 R

(57) ABSTRACT

The present invention is directed to system for repairing a cosmetic defect of a vehicle. The system comprises a portable computing device and at least one storage compartment. A plurality of articles can be stored in the compartment. Location and amount of content of the articles can be tracked and displayed on the portable computing device. The portable computing device can further contain a database for storing repair data.

### CROSS-REFERENCE TO RELATED APPLICATION

This application claims priority under 35 U.S.C. §119 from U.S. Provisional Application Ser. No. 61/219,429 (filed Jun. 23, 2009), the disclosure of which is incorporated by reference herein for all purposes as if fully set forth.

### FIELD OF INVENTION

The present invention is directed to a system for vehicle cosmetic repair. The invention is particularly directed to a system comprises a portable computing device and at least one storage compartment for storing a plurality of articles that are used for repairing cosmetic defects of a vehicle.

### BACKGROUND OF INVENTION

If a vehicle is involved in a collision or major refinishing of the vehicle is required, repair or refinishing can be typically done in a commercial refinish facility that has commercial spray equipments, spray booths, ovens, paint mixing equipments, paint color matching equipments that facilitates such a repair. Some vehicle cosmetic defects, such as small scratches on paint, flaws in the finish of a vehicle, small dents, defects in window glass or windshield, or other upholstery defects, may only require a very small or minor refinish repair. Currently vehicle owner would need to send the vehicle to a vehicle repair shop, also known as a vehicle body shop to get those defects repaired. It typically takes a few days for the repair to be completed.

A system is needed for vehicle cosmetic repair that can be completed in a short period of time without the needs for the vehicle owner to leave the vehicle in a repair shop for a few days. Some attempts have been made for such system. For example, a mobile repair facility is available for repairing small defects of a vehicle. However, due to complexity of the repair, tracking and keeping record of materials, especially paint materials, has becoming more and more challenging.

### STATEMENT OF INVENTION

This invention is directed to a system for repairing a cosmetic defect of a vehicle, said system comprising:
(A) a portable computing device comprising one or more computer program products, at least one memory device, at least one data input device, a display device, and optionally an additional data output device functionally coupled to said portable computing device; and
(B) at least one storage compartment for storing a plurality of articles, wherein said storage compartment comprises an compartment identification and each of said plurality of articles comprises an individual article identification;
   wherein said portable computing device receives from said data input device product data comprising said individual article identification, said compartment identification, or a combination thereof, and stores said product data in said memory device.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, can also be provided separately or in any sub-combination. In addition, references in the singular may also include the plural (for example, “a” and “an” may refer to one, or one or more) unless the context specifically states otherwise.

As used herein:

The term “vehicle”, “automobile” or “automobile vehicle” refers an automobile; truck; semitruck; tractor; motorcycle; trailer; ATV (all terrain vehicle); pickup truck; heavy duty mover, such as, bulldozer, mobile crane and earth mover; airplanes; boats; ships; and other modes of transport. A typical vehicle body or part thereof can be produced from a steel sheet or a plastic or a composite substrate. For example, the fenders can be of plastic or a composite and the main portion of the body of steel. If steel is used, it is first treated in a bath, typically a phosphate bath that contains an inorganic rust-proofing compound, such as, zinc or iron phosphate and then a primer coating is applied generally by E-Coat (electrodeposition). Additional coatings, such as one or more layers of basecoat that contain pigment to provide color can be applied over. Further, one or more layers of clearcoat can be applied and provides a glossy in depth appearance to the finish on the automobile or truck body and the finish has good gloss and distinctness of image (DOI).

The term “cosmetic defects” can refer to visible defects of a vehicle that are non-structural. Cosmetic defects can include coating defects, dents of a vehicle body, vehicle interior surface and finish damages, upholstery damages, glass and windshield damages, vehicle exterior surface damages, or a combination thereof. Cosmetic defects can also include flaws and other visible non-structural defects of the vehicle that are caused by mechanical or chemical actions or by atmospheric conditions, e.g., hail or acid rain.

The term “damage data” refers to a description of the cosmetic defects that can include the nature of the defect, size of the defect, location of the defect, or any other descriptions that may be needed for describing such defect.

The term “repair formula”, “repair specification” or “repair data” refers to a collection of information such as formulations, procedures, instructions, or any other information that guides an operator to repair the defect. For repairing a coating defect, the repair data typically comprise a matching coating formula. In one example, a set of repair data comprises a color formulation, a color mixing procedure and a paint application method to match and repair a color coating defect. In another example, another set of repair data comprises an instruction to find an access to the back of a metal dent on a vehicle's body with a specific make and model, a recommendation for tool selection, and a method for moving the dented metal portion to its pre-damage state. In yet another example, a set of repair data comprises an instruction on how to cut out damaged upholstery, materials needed for repair, a procedure for repair and the time needed for the repair to be set before being touched. In yet another example, repair data comprise instructions, materials, tool recommendations and procedures on how to repair a damaged windshield. A standard repair data can be readily available from one database for some common defects. An operator can use the repair data directly without modification. It is possible that more than one set of repair data are available. Under this situation, the operator can make a determination on which set to use or can choose to combine more than one sets. The operator can choose to modify a standard repair specification to fit the need of individual repair. In an event that a standard repair specification is not available for the specific defect, a skilled operator can identify a standard repair specification for a similar defect and modify it to provide the best repair.

The term “database” refers to a collection of related information that can be searched and retrieved. The database can be a searchable electronic numerical, alphanumerical or textual document; a searchable PDF document; a Microsoft Excel® spreadsheet; a Microsoft Access® database (both supplied by Microsoft Corporation of Redmond, Wash.); an Oracle® database (supplied by Oracle Corporation of Redwood Shores, Calif.); or a Linux database, each registered under their respective trademarks. The database can be a set of electronic documents, photographs, images, diagrams, or drawings, residing in a computer readable storage media that can be searched and retrieved. A database can be a single database or a set of related databases or a group of unrelated databases. “Related database” means that there is at least one common information element in the related databases that can be used to relate such databases. One example of the related databases can be Oracle® relational databases.

The term “portable computing device” used herein includes a laptop computer, a pocket PC, a personal digital assistant (PDA), a handheld electronic processing device, a mobile phone, a smart phone that combines the functionality of a PDA and a mobile phone, a tablet computer, a laptop computer, or any other electronic devices that can process information and data and can be carried by a person. A portable computing device can have a wired or wireless connection to a database or to another computing device, such as a desktop computer or a stationary server computer. A portable computing device can be a client computer that communicates with a host computer in a multi-computer client-host system connected via a wired or wireless network including intranet and internet. A host computer is a computing device that can be connected to other computers or computing devices. In one embodiment, the portable computing device is a smart phone having mobile phone functionality that can connect to a host computer through wireless phone network. In another embodiment, the portable computing device is a pocket PC. In yet another embodiment, the portable computing device is a PDA having Wi-Fi or infrared wireless connection to another computer. The portable computing device can comprise hardware including a processor, a memory, a display device and a data input device.

The term “memory member”, “memory device” or “memory” can include internal memory, random access memory (RAM), internal hard drive, memory card, removable memory card, flash memory card, writable or re-writable compact disk, compact disc Read-Only Memory (CD-ROM), or any other electromagnetic or optical devices that can be used to store and/or retrieve data. Some examples of removable or flash memory cards include

USB flash memory, SD memory card, and memory stick. Typically, a memory is functionally coupled to or accessible from a computing device or portable computing device.

The term “data input device” includes, but not limited to, a scanner, a barcode reader, an RFID (radio frequency identification device) sensor, a camera, a video camera, a memory card, a memory card reader, a hard drive, a portable hard drive, a disk drive, a compact disk drive, a cell phone, a PDA, a computer, a key board, a hand-writing recognition device, an interactive input-display device, or any other devices that can input data into a portable computing device or a other computer. The data input device can also include any devices, hardware or software that is necessary for operatively coupling the data input device to a computing device, a portable computing device or a host computer.

The term “data output device” includes, but not limited to, a printer, a fax machine, a memory card, a memory card writer, a hard drive, a portable hard drive, a disk drive, a writable compact disk drive, a cell phone, a PDA, a computer, or any other devices that can output data from a computing device or a host computer. The data output member also includes any devices, hardware or software that are necessary for operatively coupling the data output device to a computing device, a portable computing device or a host computer.

The term “network device” or “connection device” includes wired or wireless communication devices that enable the computing device to communicate with one or more electronic devices, such as a data input device, a data output device, or a host computer, through wired or wireless connections. The network device can also provide wired or wireless connections to couple one or more data input or data output devices to the computing device or the portable computing device.

The term “wired communication devices” or “wired connections” refers to a “network device” or “connection device” and can include hardware couplings, splitters, connectors, cables or wires.

The term “wireless communication devices”, “wireless connection” or “wireless device” refers to a “network device” or “connection device” and can include, but not limited to, Wi-Fi device, Bluetooth device, wide area network (WAN) wireless device, Wi-Max device, local area network (LAN) device, 3G broadband device, infrared communication device, optical data transfer device, radio transmitter and optionally receiver, wireless phone, wireless phone adaptor card, or any other devices that can transmit signals in a wide range of electromagnetic wavelengths including radio frequency, microwave frequency, visible or invisible wavelengths.

This invention is directed to a system for repairing a cosmetic defect of a vehicle. The system can comprise:
(A) a portable computing device comprising one or more computer program products, at least one memory device, at least one data input device, a display device, and optionally an additional data output device functionally coupled to said portable computing device; and
(B) at least one storage compartment for storing a plurality of articles, wherein said storage compartment comprises an compartment identification and each of said plurality of articles comprises an individual article identification;
   wherein said portable computing device receives from said data input device product data comprising said individual article identification, said compartment identification, or a combination thereof, and said portable computing device stores said product data in said memory device.

The portable computing device can be selected from a laptop computer, a personal digital assistant (PDA), a pocket PC, a tablet computer, a cell phone, or a smart phone. The data input device can be selected from a built-in or external keyboard of the portable computing device, a barcode reader, a scanner, an RFID reader, an image receiver, a wired or wireless data receiver, or a combination thereof. The data input device can be functionally coupled to the portable computing device via a wired or wireless connection device.

The display device can be a screen or a touch screen of the portable computing device. The additional data output device can be selected from a second display such as a large monitor screen, a projector, or a TV; a printer functionally coupled to said portable computing device; a memory device; a second memory device; a wired or wireless data transmitter; or a combination thereof. The data input or the data output device can be coupled to the portable computing device via a wired or wireless connection device.

The storage compartment can be a cabinet. The compartment identification can be selected from a barcode, a number, a string of numbers, a character, a string of characters, a string of alphanumeric characters, a symbol, an RFID tag, a microchip, or a combination thereof. The storage compartment can have multiple shelves, racks, drawers, holders, hangers, hooks, or any other storage spaces or sub-compartments. Typically, the storage compartment can have a number drawers that each can optionally have one or more rack, holders, containers or other types of fixtures for holding an article or a plurality of articles. The drawers can have locks to control access to the articles stored inside. The storage compartment can have movable shelves for easy access to the stored articles. Fixtures, such as holders can be used in the storage compartment to hold an article in place or to provide protection. The shelves or the racks can be staggered or movable. In one example, one or more shelves are arranged in an angle so articles placed on those shelves can be easily visible. The storage compartment can also have one or more concealed storage spaces or enclosures.

The storage compartment can be made of metal, wood, plastic or other materials. In one example, the storage compartment is a metal cabinet constructed from steel. In another example, the storage compartment is made from aluminum. In yet another example, the storage compartment is made from plastic. In yet another example, the storage compartment is made from a combination of metal, wood and plastic. For storing paints and organic solvents, a metal cabinet is preferred. The metal cabinet can further be made fire-proof, explosion proof, or both fire-proof and explosion-proof.

The plurality of articles can comprise at least one selected from coating repair articles, plastic repair articles, dent repair articles, glass repair articles, upholstery repair articles, or a combination thereof. The coating repair articles can be selected from one or more paints stored in individual containers, one or more pigment stored in individual containers, a pigment mix, one or more solvents stored in individual containers, one or more solvent mixtures, cleaners, brushes, sand papers, buffing medium, or a combination thereof.

The individual article identification can be selected from a barcode, a number, a string of numbers, a character, a string of characters, a string of alphanumeric characters, a symbol, an RFID tag, a microchip, or a combination thereof. The article identification can be affixed to individual article or embedded in the content of the article. One example of embedded article identification can be magnetic or electronically addressable particles mixed into a liquid or powder paint.

In the system of this invention, the portable computing device can comprise a computer program product that causes the portable computing device to perform a computing process comprising the steps of:
i) receiving a first individual article identification of a first of the plurality of articles;
ii) receiving a first set of descriptive data of said first of the plurality of articles, wherein said first set of descriptive data is associated with said first individual article identification;
iii) receiving a subsequent individual article identification of a subsequent of the plurality of articles;
iv) receiving a subsequent set of descriptive data of said subsequent of the articles, wherein said subsequent set of descriptive data is associated with said subsequent individual article identification;
v) generating inventory data of the of articles according to said first and subsequent individual article identifications and said first and subsequent set of descriptive data; and
vi) outputting the inventory data to the display device or the additional data output device.

The portable computing device can be a client computer of a client-host computer system, said client computer is functionally coupled to a host computer via wired or wireless connection device.

The descriptive data can comprise name of the article, initial quantity of the article, spent quantity of the article. The descriptive data can further comprise technical descriptions of an article, such as color, material, size, weight, safety procedures, or any other descriptions that are typically useful for handling the article.

The system of this invention can comprise two or more storage compartments, each of the storage compartments comprising individual compartment identification.

The portable computing device can comprise a computer program product that causes the portable computing device to perform a computing process comprising the steps of:
i) receiving a first individual article identification of a first of the plurality of articles in a first storage compartment;
ii) receiving a first set of descriptive data of said first of the plurality of articles, wherein said first set of descriptive data is associated with said first individual article identification;
iii) receiving a subsequent individual article identification of a subsequent of the plurality of articles in said first storage compartment;
iv) receiving a subsequent set of descriptive data of said subsequent of the articles, wherein said subsequent set of descriptive data is associated with said subsequent individual article identification;
v) optionally, repeating steps i) to iv) for subsequent storage compartments;
vi) generating inventory data of the articles according to said individual article identifications and said descriptive data; and
vii) outputting the inventory data to the display device or the additional data output device.

In the system of this invention, the computing process can further comprise the steps of comparing the inventory data with an inventory threshold and generating an order data if the inventory data is below the inventory threshold. For example, if one or more paint cans have paint contents less than a pre-set threshold, such as less than a certain fraction of volume or certain weight of the can, an order data can be generated to order that paint to replenish the storage.

The portable computing device can also comprise a computer program product that causes the portable computing device to perform a computing process comprising the steps of:
(i) receiving from the input device vehicle data of the vehicle;
(ii) receiving damage data of the vehicle from the input device;
(iii) retrieving repair data from the memory device based on the vehicle data and the damage data; and
(iv) displaying the repair data on the display device.

The vehicle data can be selected from manufacturer of the vehicle, vehicle identification number (VIN) of the vehicle, part of the VIN, model of the vehicle, model year of the vehicle, paint color code of the vehicle, a manufacturer plant site of the vehicle, or a combination thereof. In most countries today, VINs are required by law. For example, the U.S. government currently requires all cars and trucks made for sale in U.S. to carry a 17-character vehicle identification number, which is made up of a combination of 17 numbers and letters. Each position in the VIN (numbered from left to right) is assigned a certain meaning which is applicable to all vehicle manufacturers, all of which is public information (Federal Register, Vol. 61, No. 111, Rules and Regulations, Page 29031-29036, Jun. 7, 1996).

Vehicle data can be retrieved from a vehicle database. Vehicle data used herein can include manufacturing information such as make, model, model year, vehicle body style, site of manufacture, production sequence, and other information of the vehicle that are provided by a vehicle manufacturer, which can be retrieved based on the VIN. The vehicle data can also include paint information that can comprise paint color code. The vehicle data can further include other data, such as refinish coating formulations, instructions on repair process and materials that are developed by vehicle manufacturers, refinish coating providers, or vehicle parts suppliers. For example, some coating providers have developed vehicle refinish coating formulations for repairing vehicle coating defects and those coating formulations can be retrieved based on the VIN or a part of the VIN.

The vehicle data can further include a diagram of a vehicle specific to vehicle body style that can be identified based on the VIN. The vehicle diagram can be retrieved from a diagram database based on the vehicle body style identified by the VIN. The diagram database can be part of the vehicle database. The vehicle diagram can also be generated dynamically based on vehicle body style identified by the VIN by a computing device and stored in a temporary database. For example, if the VIN indicates that vehicle body style of the vehicle for repair is a sedan, then a diagram of a sedan can be retrieved as part of the vehicle data. The diagram database containing vehicle diagrams including the temporary database can be operatively residing in the portable computing device used for this invention or in other computer or computing device, such as a host computer operatively communicating with the portable computing device. The diagram database containing vehicle diagrams can also be part of another database, such as the aforementioned vehicle database. In one example, a vehicle diagram is retrieved from a database residing in a portable computing device based on vehicle body style identified by the VIN. In another example, a vehicle diagram is retrieved from a database residing in a host computer based on the vehicle body style identified by the VIN. In a preferred embodiment, the vehicle identification data comprise VIN and paint color code of a vehicle, wherein vehicle data such as manufacturer of the vehicle, manufacturer plant site of the vehicle, model and model year of the vehicle, and body style of the vehicle, can be retrieved based on the VIN from the vehicle database. It is understood, that the vehicle database can comprise additional information about the vehicle that are provided by the vehicle manufacturer or refinish or aftermarket vendors. It is preferred that said vehicle database comprises vehicle data that can be retrieved by VIN or part of VIN. Commercial vehicle databases readily available from vehicle manufacturers or vehicle refinish companies are suitable for this invention.

In the system of this invention, the storage compartments can be portable storage compartments. Examples of such portable storage compartments can include, but not limited to, storage cabinets with wheels so the cabinet can be moved around; a storage compartment installed in a vehicle, such as in a truck, a car, a van, or a bus; a storage box that can be carried by a person; or any other containers or boxes that can be used for storage and can be moved.

In one example, the cosmetic defect is a paint scratch of a car that is to be repaired. Vehicle data, such as VIN, part of the VIN, or paint information including paint color code can be entered into the portable computing device through the input device or by selecting from a user interface of the portable computing device. Damage data of the vehicle can be entered from the input device. Repair data can be retrieved from the memory of the portable computing device based on the vehicle data and the damage data. The repair data can be displayed on the display device. The repair data can comprise paint formulas and any variants corresponding to the paint information thereof. A matching paint formula or a variant of the matching paint formula can be selected.

Typically, the pain formula can have a plurality of components. The formula can define the amount of each of the components by weight or volume. In one example, the matching formula is selected and a matching paint is prepared based on the matching formula. Certain amounts of paint components, such as various pigments, solvents, and other ingredients are measured and taken out of the storage containers that are stored in the cabinet. The portable computing device records the individual article identifications of the containers and the amounts of the components that have been removed from the containers based on the matching formula. The amount of component remaining in the container can be compared to a pre-set threshold. If the amount is less than the pre-set threshold, an order can be generated to replenish the components.

The portable computing device can further comprise a computer program product that causes the portable computing device to perform a computing process comprising the steps of recording and tracking locations of articles stored in the compartments. Each compartment or cabinet can have location identifications, such as rack ID, raw numbers or position numbers. The location identifications can be entered into the portable computing device manually. Such identification can also be recorded automatically. In one example, each article is labeled with an RFID and the compartment is equipped with RFID readers. When an article is placed at a certain location, the RFID reader senses the location of the article and sends a signal to the portable computing device to record its location. A location map can be generated for one or more articles. Each article can be represented as an icon or a symbol on the location map. The location map can be displayed on a display device, such as the display screen of a PDA. An amount of content in each of the articles can also be displayed on the display device, The amount of content of each article can also be display as part of the icon or the symbol representing the individual article. For example, when a container is full, an icon representing a full container can be displayed. When the container is half full, an icon representing a half full container can be displayed.

One advantage of the system of this invention is that the portable computing device can produce an inventory of the articles stored in the storage compartments and keep tracking the usage of the articles. When the inventory of one or more of the articles fall below a pre-set level (also referred to as “pre-set threshold”), the portable computing device can generate an order list to replenish the storage.

Another advantage of the system of this invention is that the system can provide easy access to the articles stored in the compartments: an user can use a PDA to easily track whether there is a particular article, amount of a certain article, and location of an article. This particularly useful when a plurality of articles are stored and different amounts of individual articles are needed for different repair.

What is claimed is:

1. A system for repairing a cosmetic defect of a vehicle, said system comprising:
(A) a portable computing device comprising one or more computer program products, at least one memory device, at least one data input device, a display device, and optionally an additional data output device functionally coupled to said portable computing device; and
(B) at least one storage compartment for storing a plurality of articles, wherein said storage compartment comprises an compartment identification and each of said plurality of articles comprises an individual article identification;
wherein said portable computing device receives from said data input device product data comprising said individual article identification, said compartment identification, or a combination thereof, and stores said product data in said memory device.

2. The system of claim 1, wherein said plurality of articles comprise at least one selected from coating repair articles, plastic repair articles, dent repair articles, glass repair articles, upholstery repair articles, or a combination thereof.

3. The system of claim 2, wherein said coating repair articles are selected from a container of paint, a container of pigment, a container of a pigment mix, or a combination thereof.

4. The system of claim 1, wherein said storage compartment is a cabinet.

5. The system of claim 1 wherein said portable computing device is selected from a laptop computer, a personal digital assistant (PDA), a pocket PC, a tablet computer, a cell phone, or a smart phone.

6. The system of claim 1, wherein said data input device is selected from a barcode reader, a scanner, an RFID reader, an image receiver, a wired or wireless data receiver, or a combination thereof.

7. The system of claim 1, wherein said data input device is coupled to said portable computing device via a wired or wireless connection device.

8. The system of claim 1, wherein said additional data output device is selected from a second display device, a printer, a second memory device, a wired or wireless data transmitter, or a combination thereof.

9. The system of claim 1, wherein said compartment identification is selected from a barcode, a number, a string of numbers, a character, a string of characters, a string of alphanumeric characters, a symbol, an RFID tag, a microchip, or a combination thereof.

10. The system of claim 1, wherein said additional data output device is coupled to said portable computing device via a wired or wireless connection device.

11. The system of claim 1, wherein said individual article identification is selected from a barcode, a number, a string of numbers, a character, a string of characters, a string of alphanumeric characters, a symbol, an RFID tag, a microchip, or a combination thereof.

12. The system of claim 1, wherein a first of said one or more computer program products when installed in said portable computing device causes said portable computing device to perform a computing process comprising the steps of:
i) receiving a first individual article identification of a first of the plurality of articles in a first storage compartment;
ii) receiving a first set of descriptive data of said first of the plurality of articles, wherein said first set of descriptive data is associated with said first individual article identification;
iii) receiving a subsequent individual article identification of a subsequent of the articles in said first storage compartment;
iv) receiving a subsequent set of descriptive data of said subsequent of the articles, wherein said subsequent set of descriptive data is associated with said subsequent individual article identification;
v) optionally, repeating steps i) to iv) for a subsequent storage compartment;
vi) generating inventory data of the articles according to said individual article identifications and said descriptive data; and
vii) outputting the inventory data to said display device or said additional data output device.

13. The system of claim 12, wherein said additional data output device comprises a display screen, the memory device of the portable computing device, a printer functionally coupled to said portable computing device, or a combination thereof.

14. The system of claim 12, wherein said portable computing device is a client computer of a client-host computer system, said client computer is functionally coupled to a host computer via wired or wireless connection device.

15. The system of claim 14, wherein said additional data output device comprises a display screen of said portable computing device, the memory device of the portable computing device, a printer functionally coupled to said portable computing device, a display screen of said host computer, a memory device of said host computer, a printer functionally coupled to said host computer, or a combination thereof.

16. The system of claim 12, wherein at least one of said plurality of articles is selected from a container of paint, a container of pigment, or a container of a pigment mix.

17. The system of claim 12, wherein each set of said descriptive data comprise a name of each of the plurality of articles, initial quantity of each of the plurality of articles, spent quantity of each of the plurality of articles.

18. The system of claim 12, wherein the computing process further comprises the steps of comparing the inventory data with a inventory threshold and generating an order data if the inventory data is below the inventory threshold.

19. The system of claim 12, wherein said first of the one or more computer program products further comprises the steps of:
i) receiving location identification of each of the articles;
ii) generating a location map based on the location identification;
iii) displaying the location map on a display device, wherein locations of the articles are displayed on the location map; and
iv) displaying an amount of content of each of the articles on said location map based on said inventory data.

20. The system of claim 1, wherein a second of said one or more computer program products when installed on said portable computing device causes the portable computing device to perform a computing process comprising the steps of:
(i) receiving from the input device manufacturer information, paint information and optionally model of the vehicle;
(ii) retrieving one or more repair paint formulas and any variant paint formulas from the memory device based on the manufacturer and the paint information, and optionally model of the vehicle; and
(iii) displaying the one or more repair paint formulas and any variant paint formulas on the display device.

21. The system of claim 1, wherein a third of said one or more computer program products when installed on said portable computing device causes the portable computing device to perform a computing process comprising the steps of:
(i) receiving from the input device vehicle data of the vehicle;
(ii) receiving damage data of the vehicle from the input device;
(iii) retrieving repair data from the memory device based on the vehicle data and the damage data; and
(iv) displaying the repair data on the display device.

22. The system of claim 21, wherein said vehicle data is selected from manufacturer of the vehicle, vehicle identification number (VIN) of the vehicle, part of the VIN, model of the vehicle, model year of the vehicle, paint color code of the vehicle, a manufacturer plant site of the vehicle, or a combination thereof.

23. The system of claim 1, wherein forth of said one or more computer program products when installed on said portable computing device causes the portable computing device to perform a computing process comprising the steps of:
(i) receiving location identification of each of the articles;
(ii) generating a location map based on the location identification; and
(iii) displaying the location map on a display device, wherein locations of the articles are displayed on the location map.

24. The system of claim 1, wherein said at least one storage compartment is a portable compartment.

25. The system of claim 1, wherein said at least one storage compartment is fire-proof and optionally explosion-proof.
